(19) United States
(12) Patent Application Publication
(10) Pub. No.: US 2025/0221456 A1
(43) Pub. Date: Jul. 10, 2025

(54) HEATING SHEET, ATOMIZATION CORE, ATOMIZATION DEVICE, AND ELECTRONIC CIGARETTE

(71) Applicant: Shenzhen Eigate Technology Co., Ltd., Shenzhen (CN)

(72) Inventor: Tuanfang LIU, Shenzhen (CN)

(21) Appl. No.: 19/000,808

(22) Filed: Dec. 24, 2024

Related U.S. Application Data
(63) Continuation-in-part of application No. PCT/CN2024/128758, filed on Oct. 31, 2024.

(30) Foreign Application Priority Data
Jan. 5, 2024 (CN) 202410021681.3
Jan. 5, 2024 (CN) 202420042756.1

(51) Int. Cl. A24F 40/46; A24F 40/485; H05B 3/22

(52) U.S. Cl. CPC A24F 40/46; A24F 40/485; H05B 3/22

(57) ABSTRACT

A heating sheet, including: an absorption base for an atomization substance and a heating body. The absorption base for an atomization substance includes a plurality of pores arranged in a predetermined rule, and the atomization substance is adsorbed in the plurality of pores. The heating body is attached to the surface of the absorption base, and the atomization substance adsorbed in the plurality of pores is guided to the heating body to form an aerosol.

### CROSS-REFERENCE TO RELATED APPLICATIONS

This application is a continuation-in-part of International Patent Application No. PCT/CN2024/128758 with an international filing date of Oct. 31, 2024, designating the United States, now pending, further claims foreign priority benefits to Chinese Patent Application No. 202410021681.3 filed Jan. 5, 2024, and to Chinese Patent Application No. 202420042756.1 filed Jan. 5, 2024. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of atomization technology, and more particularly to a heating sheet, an atomization core, an atomization device, and an electronic cigarette.

An electronic cigarette (also referred to as an “e-cigarette”) or vaping device is an electronic delivery system used to generate an aerosol of an atomization substance for vaping by a user. The atomization substance may be a liquid (e.g., tobacco liquid, etc.) or a solid or gel (e.g., tobacco paste).

Typically, conventional e-cigarettes primarily include an atomizing cartridge that stores the atomization substance and a power supply device. The atomizing cartridge includes a heating or vaporizing device, such as an atomizer including an atomization core, and the power supply device supplies power to the atomizing cartridge so that the atomization substance in the cartridge is converted into an aerosol for the user to inhale. In many e-cigarettes, the inhalation of the user activates the atomizing cartridge to vaporize, for example, the atomization substance in liquid form in the cartridge, and the user then inhales the resulting aerosol through the mouthpiece.

The atomization core is a key component of the e-cigarette, and directly affects the formation of the aerosol, thereby affecting the user's experience. Existing heating sheets in the atomization core have problems such as uneven heating and easiness to burn, so there is a need to provide a heating sheet and atomization core with stable taste, even e-liquid supply, and not easy to burn.

### SUMMARY

In one aspect, the disclosure provides a heating sheet, comprising: an absorption base for an atomization substance, the absorption base comprising a plurality of pores arranged in a predetermined rule, and the atomization substance being adsorbed in the plurality of pores; and a heating body attached to a surface of the absorption base, and the atomization substance adsorbed in the plurality of pores being guided to the heating body to form an aerosol.

In another aspect, the disclosure provides an atomization core, comprising: a shell, the shell comprising an airflow inlet, an airflow outlet, an accommodation space between the airflow inlet and the airflow outlet, and an atomization substance inlet communicating with the accommodation space; an atomization base disposed in the accommodation space, the atomization base comprising an atomization channel and an opening, the atomization channel communicating with the airflow inlet and the airflow outlet, and the opening communicating with the atomization substance inlet and the atomization channel; and the heating sheet disposed in the atomization base, the heating body being oriented toward the atomization channel, and a surface of the absorption base opposite the heating body being oriented toward the atomization substance inlet.

In a further aspect, the disclosure provides an atomization device comprising: the atomization core and a housing; the atomization core is disposed in the housing, and a storage chamber is formed between the atomization core and the housing for storing the atomization substance.

In a still further aspect, the disclosure provides an electronic cigarette comprising: the atomization device, and a power supply module for supplying power for the atomization device.

The following advantages are associated with the heating sheet, the atomization core, and the atomization device of the disclosure. The heating sheet of the disclosure comprises an absorption base and a heating body attached to a surface of the absorption base, and the absorption base comprises a plurality of pores arranged in a predetermined rule. The atomization substance reaches the heating body under the absorption and guiding capabilities of the plurality of pores arranged in accordance with a predetermined rule in the absorption base, and is heated and atomized at the heating body. The heating body is directly attached to the absorption base comprising a plurality of pores, leading to a larger heating contact area and more uniform heating. Moreover, the plurality of pores arranged in accordance with a predetermined rule (i.e., having a certain regular distribution) can improve the uniformity and heating rate of the atomization substance. This can lead to the formation of a softer and more consistent aerosol that is less prone to problems such as a burned core. In addition, by providing a plurality of pores for liquid conduction directly within the absorption base supporting the heating body, it is also possible to reduce the number of components of the heating sheet and to reduce the thickness of the heating sheet.

### BRIEF DESCRIPTION OF THE DRAWINGS

FIG. 1 is a stereograph of a heating sheet according to one embodiment of the disclosure;

FIG. 2 is another stereograph of a heating sheet in FIG. 1;

FIG. 3 is an exploded view of the heating sheet in FIG. 1;

FIG. 4 is a stereograph of a heating sheet according to another embodiment of the disclosure;

FIG. 5 is another stereograph of a heating sheet in FIG. 4;

FIG. 6 is an exploded view of the heating sheet in FIG. 4;

FIG. 7 is an exploded view of an atomization core comprising the heating sheet in FIG. 1; FIG. 7 is also an exploded view of an atomization device comprising the atomization core;

FIG. 8 is a sectional view of the atomization device in FIG. 7;

FIG. 9 is an another sectional view of the atomization device in FIG. 7;

FIG. 10 is a schematic diagram of an electronic cigarette comprising the atomization core in FIG. 7;

FIG. 11 is an exploded view of the electronic cigarette in FIG. 10;

FIG. 12 is a stereograph of an atomization core according to a third embodiment of the disclosure;

FIG. 13 is a stereograph of a heating sheet and a fixing base according to the third embodiment of the disclosure;

FIG. 14 is a stereograph of a fixing base according to the third embodiment of the disclosure;

FIG. 15 is a stereograph of an atomization core according to a fourth embodiment of the disclosure; and

FIG. 16 is a stereograph of a heating sheet and a fixing base according to the fourth embodiment of the disclosure.

In the drawings, the following reference numbers are used: 10/10′: Heating sheet; 11/11′: Absorption base; 12/12′: Heating body; 13/13′: Electrode pole; 14/14′: Electrode contact; 15/15′: Bending part;

100. Atomization core; 110. Shell; 120. Atomization base; 130. Sealing cap; 111. Airflow inlet; 112. Airflow outlet; 113. Accommodation space; 114. Atomization substance inlet; 115. Slot; 121. Atomization channel; 122. Opening; 131. Airflow through-hole; 61. Absorbing material;

1000. Atomization device; 1100. Housing; 1200. Housing body; 1300. Base; 1400. Magnetic part; 1500. Sealing part; 1600. Mouthpiece; 1700. Guide pipe; 1800. electrode piece;

3000. Electronic cigarette; 2000. Power supply module.

### DETAILED DESCRIPTION

To further illustrate the disclosure, embodiments detailing a heating sheet, an atomization device, and an electronic cigarette are described below. It should be noted that the following embodiments are intended to describe and not to limit the disclosure.

In this disclosure, unless otherwise specified, the terms “connected”, “fixed”, etc. are to be understood in a broad sense, e.g., either directly or indirectly through an intermediate medium, or as a connection within two elements or an interaction between two elements. For those of ordinary skill in the art, the specific meaning of the above terms in the disclosure may be understood in actual need.

As used herein, “communication” refers to fluid communication, i.e., a fluid (including a liquid and/or a gas) can flow from one component to another. In addition, as used herein, communication between two components may refer to direct connectivity between two components, e.g., at least partial alignment between two holes, or connectivity through an intermediate medium.

“Atomization substance” means a mixture or auxiliary substance that can be atomized, in whole or in part, into an aerosol by an electronic or similar device.

The term “aerosol” refers to a colloidal dispersion system comprising small solid or liquid particles dispersed and suspended in a gaseous medium.

“Atomization device” means a device in which a stored atomizable substance is atomized into an aerosol by means of heat or ultrasound. An atomization core is one of the main components of an atomization device.

In the related art, the heating member of the atomization core mainly has the following two structures: one is a cotton heating core, and the other is a ceramic heating core. For the cotton heating core, the heating wire is usually wrapped around the periphery of the liquid-conducting cotton, and the cotton heating core is electrified through the battery power supply so that the heating wire is heated. After the heating wire reaches a certain temperature, the atomization substance adsorbed on the liquid-conducting cotton begins to evaporate. In the cotton heating core, the liquid-conducting cotton is in direct contact with the heating wire, and the atomization substance around the heating wire will be evaporated quickly by the heating wire, resulting in dry burning. After the atomization substance is evaporated, the liquid-conducting cotton is easily burned by the heating wire, affecting the taste of smoke. In addition, compared with the cotton heating core, the ceramic heating core includes ceramic sintered around the heating wire. Even if the ceramic has the characteristics of high temperature resistance, the sintered ceramic is prone to produce internal pores with irregular distribution, resulting in unstable taste.

The disclosure provides a heating sheet comprising an absorption base and a heating body. A plurality of pores are disposed in a preset rule in the absorption base for adsorbing the atomization substance, so that the atomization substance can arrive at the heating body directly through the plurality of pores in the absorption base to heat up the heating body, so as to make the heating contact area larger and the heating more uniform, thus improving the uniformity and heating rate of the aerosol, resulting in a softer and more consistent aerosol, which is less prone to problems such as a burned atomization core.

The heating sheet of the disclosure can achieve the advantages of both the good taste of the cotton atomization core and the high stability of the ceramic atomization core, and meanwhile overcomes the problems of poor consistency of the ceramic atomization core and poor durability of the cotton atomization core in the related art. In addition, compared to the cotton atomization core (which requires manual assembly by hand), the heating sheet of the disclosure can be automatically manufactured, thereby improving the production efficiency. Moreover, by directly providing a plurality of pores for liquid conduction within the absorption base, the components of the heating sheet are saved and the thickness of the heating sheet is reduced.

The atomization core of the disclosure may be used in an electronic cigarette. In the disclosure, an “electronic cigarette” refers to a system in which an atomization substance, such as a tobacco liquid (specifically, tobacco liquid, etc.), is atomized or the like to generate an aerosol for a person to draw, suck, chew, or snort, etc. In some examples, the e-cigarette may include a storage chamber for storing the atomization substance and an atomization core for adsorbing and atomizing the atomization substance to form an aerosol. The atomization substance may be in a liquid form (e.g., smoke liquid) or a solid or gel form (e.g., smoke paste), etc. It should be understood herein that the atomization cores of the disclosure may also be used in other devices that require atomization of an atomization substance, such as, for example, medical nebulizers, skin care instruments, aromatherapy devices, and the like.

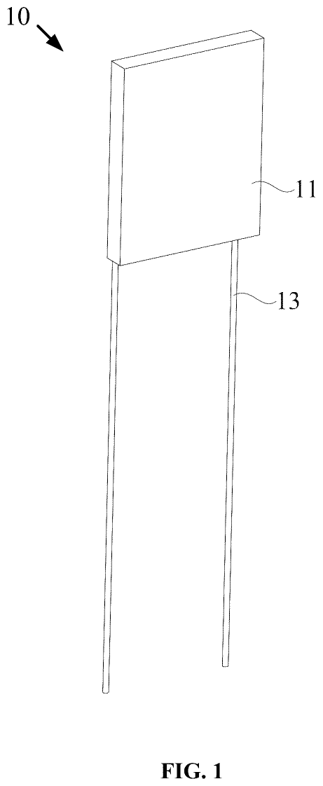

FIGS. 1 to 9 provide a heating sheet and an atomization core of the disclosure.

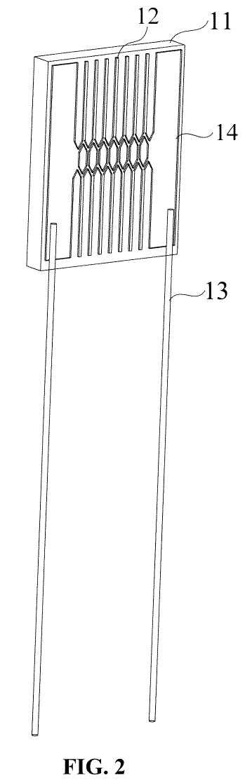

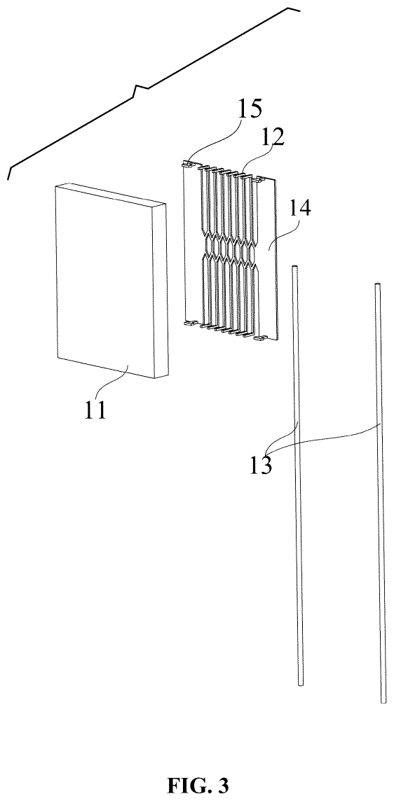

FIG. 1 is a stereograph of a heating sheet according to one embodiment of the disclosure; FIG. 2 is another stereograph of a heating sheet in FIG. 1; FIG. 3 is an exploded view of the heating sheet in FIG. 1.

As shown in FIGS. 1 to 3, the heating sheet 10 for atomizing an atomization substance to form an aerosol comprises an absorption base 11 and a heating body 12.

A plurality of pores are arranged in a predetermined rule in the absorption base 11, and the heating body 12 is attached to a surface of the absorption base 11; the plurality of pores are used to adsorb the atomization substance and direct the adsorbed atomization substance to the heating body 12.

In certain embodiments, the atomization substance reaches the heating body 12 under the absorption and guiding action of the plurality of pores arranged in accordance with a predetermined rule in the absorption base 11 and is heated and atomized at the heating body 12. The heating body is directly attached to the absorption base comprising a plurality of pores, leading to a larger heating contact area and more uniform heating. Moreover, the plurality of pores arranged in accordance with a predetermined rule (i.e., having a certain regular distribution) can improve the uniformity and heating rate of the atomization substance. This can lead to the formation of a softer and more consistent aerosol that is less prone to problems such as a burned core. In addition, by providing a plurality of pores for liquid conduction directly within the absorption base supporting the heating body, it is also possible to reduce the number of components of the heating sheet and to reduce the thickness of the heating sheet.

The plurality of pores of the absorption base of the disclosure can adsorb and guide the atomization substance by capillary action, which can avoid direct contact between the heating body 12 and the atomization substance, and further avoid the atomization substance (e.g., tobacco liquid) from impacting the heating body 12 in the event of excessive flow rate, which may result in the direct entry of the atomization substance into the atomization channel without atomization.

In some embodiments, the heating body 12 may, for example, be made of iron-chromium aluminum or nickel-chromium alloy; the absorption base 11 serves as a conductor of the heating sheet 10, and the heating body 12 is affixed to the back of the absorption base 11 to serve as a heat generator.

As shown in FIGS. 1 to 3, the electrode pole 13 comprises a positive electrode and a negative electrode, which are electrically connected to the electrode contact 14 (specifically, a positive electrode contact, a negative electrode contact) of the heating body 12, and energized with an external power supply to supply power to the heating body 12. The heating body 12 is used to heat the atomized substance in the storage chamber (e.g., the liquid storage chamber) adsorbed by the absorption base 11 and guided to pass onto the heating body 12, thereby forming an aerosol.

Optionally, as shown in FIGS. 2 and 3, two electrode contacts 14 are disposed on both sides of the heating body 12, and the two electrode contacts may be electrode contact sheets extending over the entire length of the absorption base 11. A heating wire with a planar mesh structure is disposed between the two electrode contacts. For example, the heating wires are arranged in an array row and have a diamond shape in the center. The heating wire may extend over the entire length of the absorption base 11. This helps to uniformly heat the atomization substance thereby promoting uniformity of the atomization substance provided by the heating sheet 10. The planar mesh structure of the heating body 12 can be easily affixed to the absorption base 11. Furthermore, in the case where the heating body 12 does not have a mesh structure, the individual portions of the heating body 12 are equivalent to a parallel state, which can decrease the resistance value, thereby affecting the heat generation of the heating body 12. Thus, the heating body 12 with a mesh structure is conducive to increasing the amount of heat generated per unit area of the heating body 12, thereby promoting the atomization effect on the atomization substance. In addition, a planar (i.e., sheet-like) heating body generates more heat power compared to a metal coating, resulting in heavier and fuller atomization and better taste. In some examples, the planar mesh structure of the heating body 12 may be provided with a smaller mesh within the heating body 12, thereby increasing the density of the mesh and increasing the heat generation power of the heating body 12 on a single side area. A bending part 15 (including a bending portion of the electrode contact and a bending portion of the heating wire) may be provided on at least one of the two end portions of the heating body adjacent to the above-described two sides; the bending part is inserted within the absorption base to increase the firmness between the heating body and the absorption base.

In certain embodiments, the absorption base may be made of glass or the like. The glass is, for example, quartz glass, high silica glass, and the like. The quartz glass includes, but is not limited to, one of natural quartz glass, synthetic quartz glass, transparent quartz glass, opaque quartz glass, and the like. Alternatively, the absorption base may also be made of other materials capable of being processed by a laser or the like to have a plurality of pores having a predetermined regular arrangement. In contrast to the atomization cores made of cotton and ceramics used in the prior art, the quartz glass, as well as other materials, can be engraved to form a plurality of micropores or pores arranged according to a predetermined rule by means of processing, such as a laser, etc. The plurality of micropores or pores are used to adsorb the atomization substance by capillary action and are uniformly distributed over the surfaces of a plurality of monomers, thus promoting the homogeneity and efficiency of adsorption and conduction of the atomization substance (e.g., grease and fumes), and making the formed aerosol with better mouthfeel and softness.

In certain embodiments, the plurality of pores of the absorption base may also be formed by sintering. Specifically, the absorption base 11 comprises a plurality of monomers arranged such that a plurality of pores arranged according to a predetermined rule are formed between every two adjacent monomers. Compared to obtaining the plurality of pores directly on the absorption base 11 by other physical or chemical methods, the above described use of the gaps between the monomers as the pores avoids the use of a pore-forming material, which on the one hand increases the safety of generating an aerosol and avoids the generation of a bad smell, and on the other hand enhances the accuracy of the size of the plurality of pores and the rules of the arrangement, and further avoids the potential blockage of the pores. In this way, the formed liquid-guiding channel is unobstructed, ensuring more uniform and rapid adsorption and conduction of the atomization substance, promoting uniformity and consistency of the atomization substance provided by the heating sheet, and improving the conduction efficiency. Compared to cotton atomization cores and ceramic atomization cores that require 1 minute to 2 minutes to direct the atomization substance to the heating wire for heating, the heating sheet of the disclosure can improve the conduction efficiency of the atomization substance, specifically, can conduct the tobacco liquid to the heating body in 1 second to 3 seconds, and can conduct water to the heating body in a time of less than 1 second. The shape and size of each monomer in the plurality of monomers may be consistent or may be a shape and size with a certain error range, which may be specifically set as needed.

In certain embodiments, each monomer of the plurality of monomers is in the shape of a sphere. Since the plurality of monomers included in the absorption base 11 are small in size, the monomers in a sphere-like shape are easy to be processed, and the manufacturing cost can be further reduced. In addition, the sphere-shaped monomers are conveniently formed with pores of appropriate area therebetween so as to facilitate the plurality of pores to adsorb and guide the atomization substance by capillary action, thereby avoiding direct contact between the heating body 12 and the atomization substance, and further avoiding that the atomization substance (e.g., the tobacco liquid) flows to the heating body 12 at a too fast rate, resulting in a direct entry into the atomization channel without atomization. In addition, when the atomization substance supplied to the heating sheet 10 is depleted, dry burning of the heating sheet can be avoided by the atomizing substrate stored in the plurality of holes in the heating sheet 10, avoiding the generation of a burnt flavor.

In some embodiments, each of the plurality of monomers has a diameter in the range of 100 μm to 150 μm. As a result, the plurality of monomers can form a plurality of pores of a suitable size, for example, the size of the plurality of pores can be set to a micrometer level, for example, the diameters of the plurality of pores formed can be, for example, in the range of 40 μm to 50 μm, so as to allow the plurality of pores to realize the liquid-conducting and liquid-locking functions. Specifically, on the one hand, the tobacco liquid can be adsorbed and guided through the plurality of pores, and on the other hand, the tension of the atomization substance avoids it from passing through the heating sheet 10 into the atomization channel, thereby reducing the risk of leakage. In addition, the diameter in the range of 100 μm to 150 μm enables each of the plurality of monomers to withstand a higher manufacturing temperature without melting.

In certain embodiments, the plurality of monomers are made of quartz glass. The quartz glass includes, but is not limited to, natural quartz glass, synthetic quartz glass, transparent quartz glass, opaque quartz glass, and the like. The plurality of monomers made of quartz glass may increase the overall strength, damage resistance, and temperature resistance of the absorption base 11. These properties of quartz glass enable the absorption base to be used as both a support of the heating body, and be used as the guidance of the atomization substance, thereby reducing the thickness of the absorption base and increasing the service life thereof. In addition, quartz glass is extremely safe and is a food-grade material. Thus, the use of quartz glass increases the safety of the produced aerosols.

In certain embodiments, the abovementioned spherical monomers made of quartz glass have diameters in the range of 100 μm to 150 μm, thus allowing the manufactured absorption base to withstand high temperatures exceeding more than 1,000° C. and without melting, thereby increasing the service life of the heating sheet.

In some embodiments, the content of quartz glass within the absorption base 11 is greater than or equal to 90%. Thus, the use of quartz glass can further increase the service life of the heating sheet and improve the safety of the formed aerosol.

In some embodiments, the thickness of the absorption base 11 is less than 2 mm, e.g., less than 1 mm. Optionally, the thickness of the absorption base 11 may be between about 1 and 1.2 mm. The absorption base of the disclosure (e.g., formed by a plurality of monomers made of quartz glass) can be achieved with the heating sheet having a smaller volume and without compromising the strength of the absorption base.

In some embodiments, the shape of the cross-section of the absorption base 11 may be a circle, a square, and the like. In the case where the shape of the cross-section of the absorption base 11 is square, the width of the absorption base 11 may be about 7 mm, for example, and the length of the absorption base 11 may be about 9 mm. It should be understood herein that the dimensions of the absorption base 11 may be other values according to the dimensions of the atomization device.

In certain embodiments, the absorption base 11 is made by sintering a plurality of monomers in an array at a temperature between 800° C. and 900° C. without the addition of a pore-forming material. The pore-forming material includes, but is not limited to, high-temperature decomposable salts such as ammonium carbonate, ammonium bicarbonate, ammonium chloride, and other decomposable compounds such as Si₃N₄, or inorganic carbon such as pulverized coal, toner, sawdust, naphthalene, starch, and one of polyvinyl alcohol, urea, methacrylated methyl ester, polyvinyl chloride, polystyrene, and the like. After being sintered at 800° C. to 900° C., the plurality of monomers arranged in an array can be combined and the pores of suitable size can be formed between adjacent monomers without the need of a pore-forming material as described above. This avoids clogging of the pores with foreign matter generated during sintering of the pore-forming material and prevents the formation of uneven and inconsistent pores.

In certain embodiments, the heating body 12 may be sintered integrally with the plurality of monomers. As a result, the manufacturing process can be simplified and the economic efficiency is improved. In addition, the sintering process makes it more efficient to attach the heating body 12 to the absorption base 11, and the attachment is stronger and tighter, so that the heating body 12 is less likely to detach off even if the heating body 12 is operated under continuous heat in actual use. In some examples, the heating body and the plurality of monomers are injected under pressure into a mold to form an initial embryo, which is then sintered.

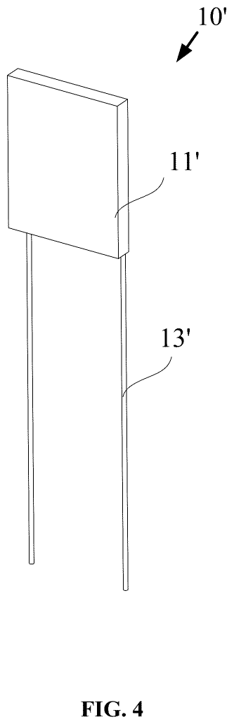

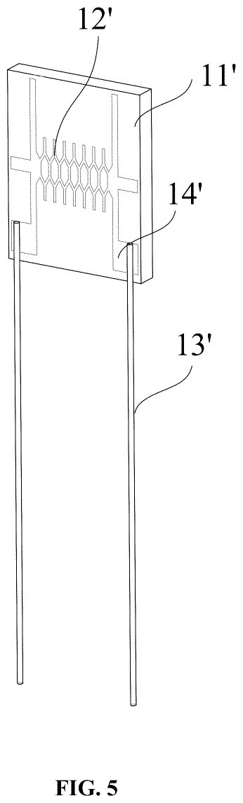

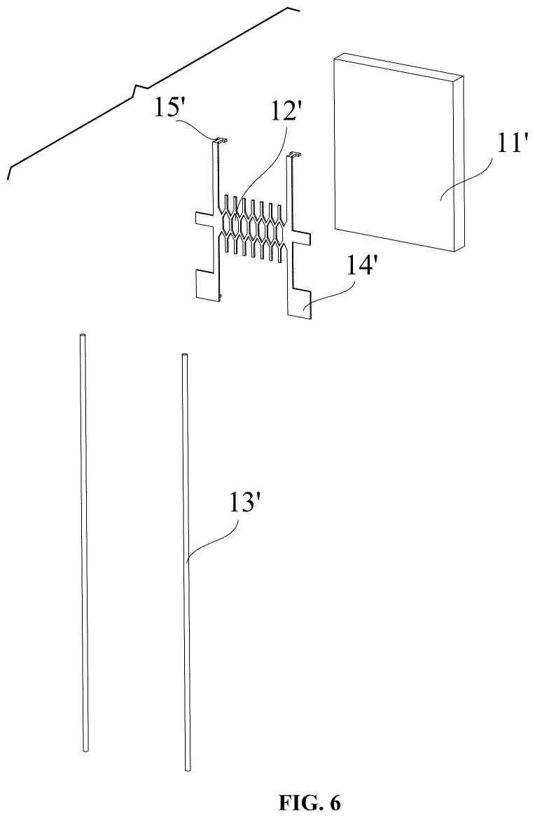

FIG. 4 is a stereograph of a heating sheet 10′ according to another embodiment of the disclosure; FIG. 5 is another stereograph of a heating sheet in FIG. 4; FIG. 6 is an exploded view of the heating sheet in FIG. 4. The characteristics of the heating body 10′ in FIGS. 4-6 are basically the same as those of the heating body 10 in FIGS. 1-3. The difference between the two is that the heating wire of the planar mesh structure in FIGS. 4-6 extends along a portion of the length direction of the absorption base 11′, and the electrode contact 14′ is a partially hollow electrode contact structure.

Specifically, a flat mesh heating wire is disposed between the two electrode contacts 14′ of the heating body 12′. The heating wire extends along a portion of the length direction of the absorption base 11. At least one end of the heating body adjacent to the two sides is provided with a bending part 15′ (including a bending portion of the electrode contact), which is inserted into the absorption base to increase the firmness between the heating body and the absorption base.

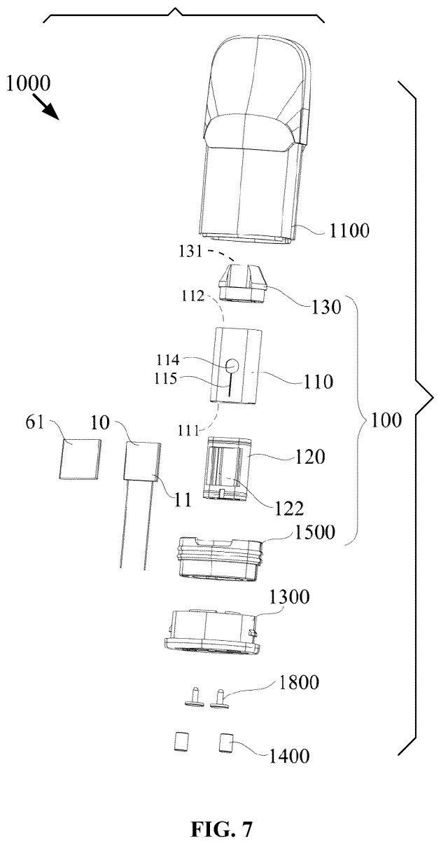

It should be understood that, in addition to the features described above, other features of the heating body 10′ (such as the features of the absorption base 11′, features of the heating body 12′, features of the electrode pole 13′ and electrode contact 14′, etc.) are the same as the features of the heating body 10 described in FIGS. 1-3, which will not be described in detail here. According to another aspect of the disclosure, there is provided an atomization core comprising the aforementioned heating sheet 10 or 10′. The atomization core 100 comprising the heating sheet 10 will be described in detail below with reference to FIGS. 7-9.

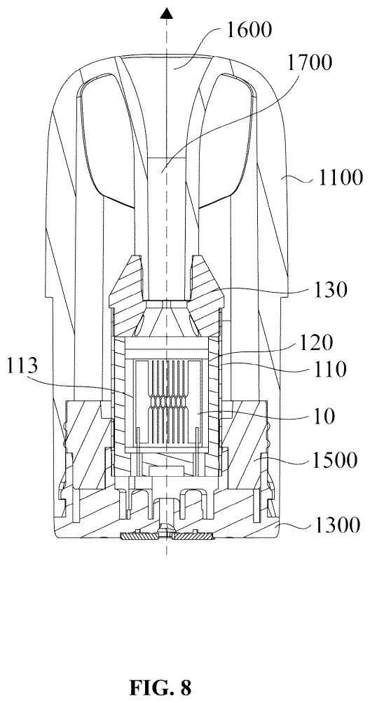

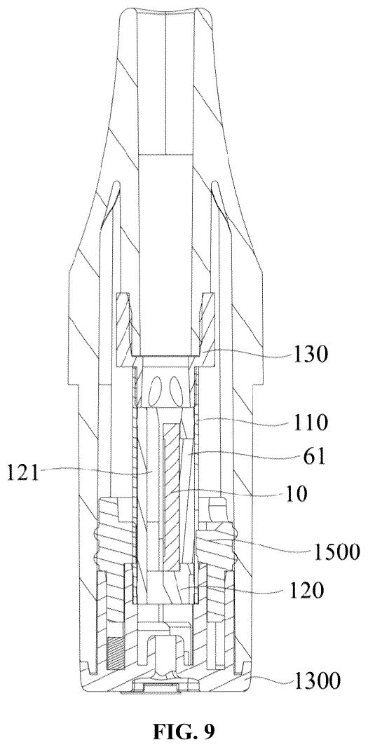

FIG. 7 is an exploded view of an atomization core 100 comprising the heating sheet 10 in FIG. 1; FIG. 7 is also an exploded view of an atomization device 100 comprising the atomization core 100 in FIG. 1; FIG. 8 is a sectional view of the atomization device in FIG. 7; FIG. 9 is an another sectional view of the atomization device in FIG. 7.

As shown in FIG. 7, the atomization core 100 comprises a shell 110, an atomization base 120, and the heating sheet 10 described with reference to FIGS. 1-3.

The shell 110 comprises an airflow inlet 111, an airflow outlet 112, an accommodation space 113 between the airflow inlet 111 and the airflow outlet 112, and an atomization substance inlet 114 communicating with the accommodation space 113.

As shown in FIG. 7, the atomization substance inlet 114 is formed on and runs through the wall of the shell so that the space outside of the shell and the accommodation space 113 can communicate with each other. Thus, the atomization substance outside of the shell 110 enters the interior of the shell 110. FIG. 7 shows the atomization substance inlet 114 functioning as a single liquid inlet hole. The atomization core having one atomization substance inlet has great resistance to negative pressure. In some other embodiments, a plurality of atomization substance inlets may also be provided.

The atomization base 120 is disposed within the accommodation space 113, and the atomization base 120 comprises an atomization channel 121 for communicating with the airflow inlet 111 and the airflow outlet 112. As shown in FIG. 9, the approximate center of the atomization base 120 forms the atomization channel 121 for the flow of air, steam, and aerosols. When the atomization base 120 is mounted within the accommodation space 113 of the shell 110, one end of the atomization channel 121 communicates with the airflow inlet 111 of the shell 110, and the other end communicates with the airflow outlet 112.

In certain embodiments, the atomization base 120 further comprises an opening 122 communicating with the atomization substance inlet 114 and the atomization channel 121. For example, as shown in FIG. 7, the atomization base 120 is provided with an opening 122 that is at least partially opposite to the atomization substance inlet 114 on the shell 110, and the heating sheet 10 is arbitrarily disposed in the opening 122. The opening 122 may be provided with a step for supporting the heating sheet 10. As the opening 122 is formed in and through the side wall of the atomization base 120, the opening 122 is opposite to the atomization substance inlet 114 and passes into the atomization channel 121, so that the atomization substance outside the shell 110 can enter the atomization channel 121 via the atomization substance inlet 114 and the opening 122.

As shown in FIGS. 7-9, the heating sheet 10 is placed inside the atomization base 120, with the heating body facing the atomization channel, and the surface of the absorption base opposite to the heating body faces the atomization substrate inlet. Thus, the atomization substance entering through the atomization substance inlet 114 (as well as the opening 122) can reach the heating sheet 10 and penetrate through the multiple pores of the absorption base on the heating sheet 10 to the heating body, where the atomization substance is heated and atomized to form aerosols.

In the above embodiment, when the user inhales at the airflow outlet 112, the airflow can reach the airflow outlet 112 through the atomization channel 121 in the atomization base 120 from the airflow inlet 111, thereby forming an airflow path. A part of the airflow path (i.e. atomization channel 121) forms the atomization chamber. One side of the heating sheet 10 is connected to the atomization substance inlet 114 through the opening 122, and the other side is in fluid communication with the air inside the atomization channel 121. The atomization substance outside the shell 110 penetrates through the atomization substance inlet 114 and the opening 122 to the absorption base 11 of the heating sheet 10, and then continues to penetrate to the heating body 12 of the heating sheet 10, thereby reaching the heating sheet on the first surface of the heating sheet. After being heated and atomized by the heating sheet, vapor is formed. The vapor is carried in the air flowing through the atomization channel 121 to form aerosols for users to inhale.

In certain embodiments, the heating sheet 10 is disposed longitudinally in the atomization base, parallel to the longitudinal extension direction of the atomization base 120 or the shell 110, so that the heating sheet does not block the airflow in the atomization channel 121 from flowing from the airflow inlet 111 to the airflow outlet 112. The design can make the formed aerosol (i.e. vapor) unobstructed, thereby improving the taste.

In some embodiments, the shell 110 is a hollow structure used to provide installation space for the atomization base 120 and form an airflow path for air flow inside the shell. The shell 110 can be made of hard materials such as copper, iron, aluminum, etc., in order to protect the various components inside and separate the storage chamber from the atomization channel 121.

In some embodiments, the atomization core 100 further comprises a sealing cap 130 disposed at one end of the shell 110 where the airflow outlet 112 is located. The sealing cap 130 comprises an airflow through-hole 131, and the airflow outlet 112 enters the airflow through-hole 131 to discharge the formed aerosol from the airflow through-hole 131. The sealing cap can guide the discharge of aerosols, and is embedded in the guide tube (which will be described in detail below) of the house of the atomization device, to separate the guide tube from the environment around the atomization core and avoid the leakage of formed aerosols.

In certain embodiments, the surface of the absorption base 11 opposite to the heating body 12 is covered on the atomization substance inlet 114. Therefore, the absorption base 11 can act as a buffering structure between the heating sheet 10 and the atomization substance, avoiding the atomization substance (such as e-liquid) from impacting the heating sheet 10 at a too fast flow rate, causing the atomization substance to enter the atomization channel directly without atomization. Instead, the atomization substance is guided to the heating body through multiple pores of the absorption base 11 for heating, thereby promoting the uniformity of heating. By using the absorption base 11 of the heating body 10 as a guiding buffer structure between the atomization substance inlet and the heating body, without the need for additional atomization substance absorption materials, the number of components can be reduced and manufacturing costs can be lowered.

In certain embodiments, as shown in FIGS. 7 and 9, to minimize the risk of leakage, the atomization core 100 further comprises an absorbing material 61. The heating sheet 10 is disposed within the atomization channel 121 of the atomization base, and the absorbing material 61 is nested within the opening 122 and disposed between the atomization substance inlet 114 and the heating sheet 10. A first side of the absorbing material 61 covers the atomization substance inlet 114 from the inside of the housing, and a second side thereof opposite the first side abuts the heating sheet 10. As a result, a cushioning structure is formed between the heating sheet 10 and the atomization substance to avoid the atomization substance (e.g., e-liquid) from impacting the heating sheet at a too fast flow rate, which may cause the atomization substance to enter the atomizing channel directly without atomization. In some examples, the absorbing material 61 may comprise cotton or woven cloth, which includes, but is not limited to, sanitary cotton, inert cotton, organic cotton, composite cotton, linen cotton, asbestos, and fiber cotton. The cotton or woven cloth comprises fibers, which have the functions of e-liquid absorption and e-liquid conduction, so as to better achieve the effect of cushioning and avoiding e-liquid excess. In addition, cotton features a uniform distribution of pores, which makes e-liquid conduction smoother.

In certain embodiments, the shell 110 comprises a slot 115, which extends from one end of the atomization substance inlet 114 facing the airflow inlet 111 towards the airflow inlet 111. The design allows the airflow from the airflow inlet 111 to flow at least partially through the slot, creating a pressure during the inhaling process by a user acting on the atomizer, and ensuring the supply of the atomization substance to the heating sheet smoother. In some embodiments, the slot 115 has a width in a direction perpendicular to the extension direction of the slot 115, and the width is between 0.05 mm and 0.35 mm. This can form a film between the edges of the slot for atomization substance such as e-liquid, thereby avoiding leakage.

In some embodiments, the size of the opening 122 is smaller than the size of the heating sheet to prevent the heating sheet 10 from falling out of the opening 122. In some other embodiments, the shape and size of the opening 122 may be set so that the heating sheet 10 can be placed inside the atomization channel 121 through the opening 122. Specifically, for example, the size of the opening 122 can be set slightly larger than the size of the heating sheet 10, or the size of the opening 122 can be set slightly smaller than the size of the heating sheet 10 and allow the heating sheet 10 to pass through, for example, at a slight inclination, and/or the shape of the opening 122 can be set to match the shape of the heating sheet 10.

The atomization core 100 further comprises an electrode pole 13, as shown in FIGS. 1-3. The electrode pole 13 comprises two electrodes for contacting the electrode contacts on the heating sheet 10. One end of electrode pole 13 can extend into the atomization base 120 to contact with the electrode contacts on the heating sheet 10, and the other end extends at least partially from the accommodation space 113 to be electrically connected to the electrode piece 1800. The materials of the electrodes include but are not limited to pure copper, graphite, brass, steel, cast iron, tungsten alloy, etc.

In another aspect, the disclosure provides an atomization device 1000 comprising the atomization core 100 and a housing 1100. The atomization core is disposed inside the housing, and a storage chamber for storing the atomization substance is formed between the inner wall of the housing and the outer wall of the atomization core. Specifically, as shown in FIGS. 7-9, the atomization device 1000 comprises the aforementioned atomization core 100 and housing 1100.

The atomization core 100 is disposed inside the housing body 1200, and the storage chamber is defined by the space between the inner wall of the housing body 1200, the base 1300, and the outer wall of the shell 110 of the atomization core. The atomization substance in the storage chamber can enter the shell through the atomization substance inlet 114.

The atomization device 1000 further comprises an electrode piece 1800 and a magnetic part 1400, and the base 1300 is provided with a through hole. The electrode pole 13 of the atomization core 100 is at least partially arranged in the through hole. One end of the electrode pole 13 is electrically connected to the electrode contact on the heating sheet, and the other end is electrically connected to the electrode piece 1800. In some embodiments, the material of the electrode piece includes but is not limited to pure copper, graphite, brass, steel, cast iron, and tungsten alloy. The material of the base 1300 can be composite plastic, etc. To prevent leakage of the atomization substance in the storage chamber from positions other than the atomization substance inlet, the base 1300 comprises a sealing part 1500 located on one side of the storage chamber.

In certain embodiments, the housing body 1200 comprises a mouthpiece 1600 and a guide tube 1700 extending inward from the mouthpiece 1600. The sealing cap 130 is embedded in the guide tube 1700 of the housing body, so that the aerosol formed by the atomization core 100 flows from the sealing cap 130 to the guide tube 1700 and exits from the mouthpiece 1600. The sealing cap 130 can separate the guide tube 1700 from the surrounding environment of the atomization core 100, thereby preventing the aerosol formed by the atomization core from leaking into the surrounding environment of the atomization core. The sealing cap 130 makes the structure of the atomization device 1000, including the atomization core 100, more compact and provides better sealing effect. In some embodiments, the base 1300 is used to accommodate the side where the airflow inlet of the atomization core 100 is located. The part of the base opposite to the atomization substance inlet is provided with grooves to avoid the atomization substance inlet, which helps to achieve effective supply of the atomization substance via the atomization substance inlet even when there is less atomization substance in the storage chamber.

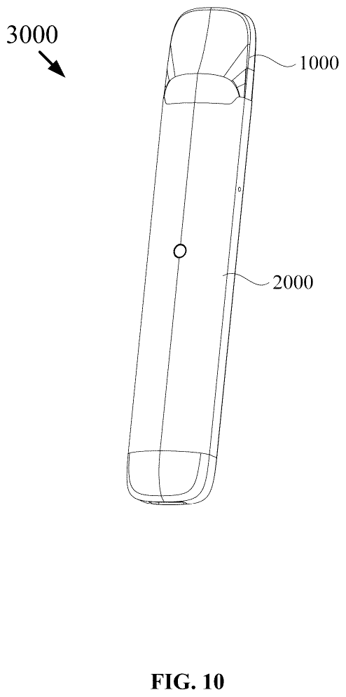

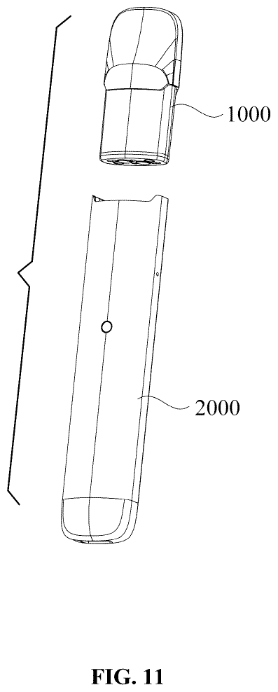

According to another aspect of the disclosure, as shown in FIGS. 10 and 11, there is provided an electronic cigarette 3000 comprising: the atomization device 1000 as described above and a power supply module 2000 (such as a battery) that supplies power to the atomization device.

The power supply module 2000 further comprises a casing and a battery cell. The casing is provided with an installation chamber, and the atomization device 1000 is inserted into the installation chamber. The electrode components of the atomization device 1000 are electrically connected to the battery cell to form a power supply circuit.

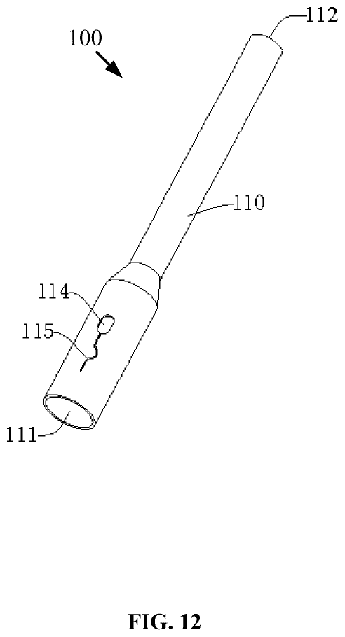

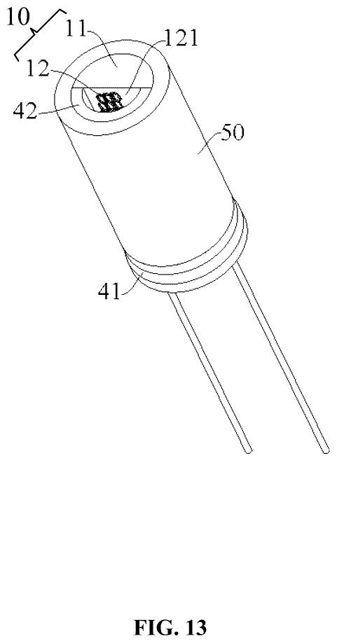

As shown in FIGS. 12-13, in another embodiment, the atomization core 100 comprises a shell 110; the heating sheet 10 is disposed in the shell 110. The shell 110 comprises an airflow inlet 111 and an airflow outlet 112. The heating sheet 10 comprises an absorption base 11 and a heating body 12; the absorption base 11 is semi-cylindrical; the shell 110 is in the form of a hollow tube. One side of the absorption base 11 has a curved wall and is adapted to fit with a part of the inner wall of the shell 110 and is connected to each other. An atomization substance inlet 114 is provided at a position corresponding to the curved wall of the shell 110, and an atomization channel 121 is formed between the other side wall of the absorption base 11 and the inner wall of the shell 110. The atomization channel 121 communicates with the airflow inlet 111 and the airflow outlet 112. The heating body 12 is located on the other side of the absorption base 11 opposite the atomization channel 121.

The shell 110 comprises a slot 115; the slot 115 extends from one end of the atomization substance inlet 114 facing the airflow inlet 111 towards the airflow inlet 112.

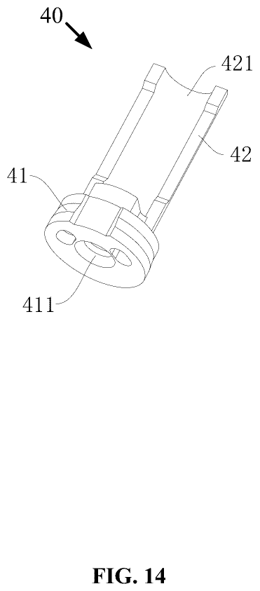

As shown in FIG. 14, the atomization core 100 further comprises a fixing base 40 for securing the heating sheet 10. The fixing base 40 comprises a support 41 and an abutting portion 42. The heating sheet 10 is disposed on the support 41, and the abutting portion 42 having one end attached to the support 41. The abutting portion 42 has a curved wall on one side. The curved wall of the abutting portion 42 is adapted to another portion of the inner wall of the shell 110, and the other side of the abutting portion 42 is oriented towards and provided with a concave portion 421. The absorption base 11 is abutted against the abutting portion 42. The atomization channel 121 is formed in the concave portion between the absorption base 11 and the abutting portion 42. The support 41 is provided with a through-hole 411 communicating with the atomization channel 121. The support 41 is used to support the heating sheet 10, and the abutting portion 42 together with the shell 110 restricts the radial movement of the heating sheet along the shell 110, ensuring the structural stability of the atomization core 100.

As shown in FIG. 13, the heating sheet 10 and the abutting portion 42 are peripherally covered with cotton 50 through which the absorption base and the abutting portion 42 are abutted against the inner wall of the shell 110. The cotton may function to absorb the atomized substrate supplied to the absorption base 11, or to insulate the heat, or both.

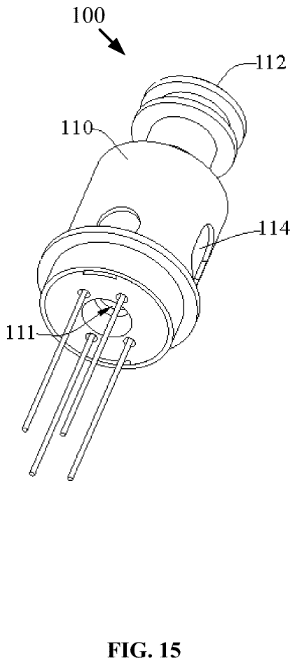

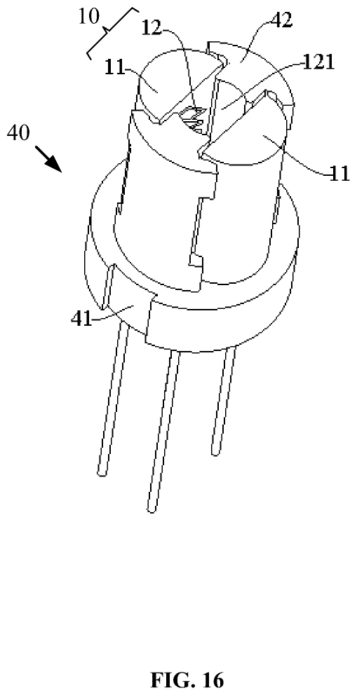

As shown in FIGS. 15-16, in another embodiment, the heating sheet 10 is still semi cylindrical in shape, and its number can be multiple. The heating sheet and the support 41 are enclosed to form the atomization channel.

The following are some examples of the disclosure.

### Example 1

A heating sheet configured to transform an atomization substance into an aerosol, and the heating sheet comprises:
an absorption base for an atomization substance, the absorption base comprising a plurality of pores arranged in a predetermined rule, and the atomization substance being adsorbed in the plurality of pores; and
a heating body attached to a surface of the absorption base;
the atomization substance adsorbed in the plurality of pores is guided to the heating body to form an aerosol.

### Example 2

According to the heating sheet in Example 1, the absorption base comprises a plurality of monomers; the plurality of monomers are arranged in a manner such that each of the plurality of pores is formed between every two adjacent monomers.

### Example 3

According to the heating sheet in Example 2, each of the plurality of monomers is spherical.

### Example 4

According to the heating sheet in Example 2, each of the plurality of monomers has a diameter of 100-150 μm.

### Example 5

According to the heating sheet in Example 2, each of the plurality of monomers comprises quartz glass.

### Example 6

According to the heating sheet in Example 5, the absorption base comprises greater than or equal to 90 wt. % of quartz glass.

### Example 7

According to the heating sheet in any of Examples 2-6, the plurality of monomers are arranged in an array; the absorption base is formed by sintering the plurality of monomers at a temperature between 800° C. and 900° C. without a pore-forming material.

### Example 8

According to the heating sheet in Example 7, the heating body is sintered together with the plurality of monomers.

### Example 9

According to the heating sheet in any of Examples 1-6, the absorption base has a thickness of less than 2 mm.

### Example 10

According to the heating sheet in any of Examples 1-6, the heating body comprises a heating wire having a planar mesh structure, and the heating wire extends at least partially along a length direction of the absorption base.

### Example 11

An atomization core comprises:
a shell, the shell comprising an airflow inlet, an airflow outlet, an accommodation space between the airflow inlet and the airflow outlet, and an atomization substance inlet communicating with the accommodation space; an atomization base disposed in the accommodation space, the atomization base comprising an atomization channel and an opening, the atomization channel communicating with the airflow inlet and the airflow outlet, and the opening communicating with the atomization substance inlet and the atomization channel; and
the heating sheet any of Examples 1-10 disposed in the atomization base, the heating body being oriented toward the atomization channel, and a surface of the absorption base opposite the heating body being oriented toward the atomization substance inlet.

### Example 12

According to the atomization core in Example 11, the surface of the absorption base opposite the heating body covers the atomization substance inlet.

### Example 13

According to the atomization core in Example 11, the shell comprises a slot; the slot extends from one end of the atomization substance inlet facing the airflow inlet towards the airflow inlet, and has a width in a direction perpendicular to an extension direction of the slot; and the width is between 0.6 and 1 mm.

### Example 14

An atomization device comprises:
the atomization core of any of Examples 11-13, and
a housing; the atomization core is disposed in the housing, and a storage chamber is formed between the atomization core and the housing for storing the atomization substance.

### Example 15

An electronic cigarette comprises:
the atomization device of Example 14, and
a power supply module for supplying power for the atomization device.

It will be obvious to those skilled in the art that changes and modifications may be made, and therefore, the aim in the appended claims is to cover all such changes and modifications.

What is claimed is:

1. A heating sheet, comprising:
an absorption base for an atomization substance, the absorption base comprising a plurality of pores arranged in a predetermined rule, and the atomization substance being adsorbed in the plurality of pores; and
a heating body attached to a surface of the absorption base, and the atomization substance adsorbed in the plurality of pores being guided to the heating body to form an aerosol.

2. The heating sheet of claim 1, wherein the absorption base comprises a plurality of monomers; the plurality of monomers are arranged in a manner such that each of the plurality of pores is formed between every two adjacent monomers.

3. The heating sheet of claim 2, wherein each of the plurality of monomers is spherical.

4. The heating sheet of claim 2, wherein each of the plurality of monomers has a diameter of 100-150 μm.

5. The heating sheet of claim 2, wherein each of the plurality of monomers comprises quartz glass.

6. The heating sheet of claim 5, wherein the absorption base comprises greater than or equal to 90 wt. % of quartz glass.

7. The heating sheet of claim 2, wherein the plurality of monomers are arranged in an array.

8. The heating sheet of claim 2, wherein the absorption base is formed by sintering the plurality of monomers at a temperature between 800° C. and 900° C. without a pore-forming material.

9. The heating sheet of claim 8, wherein the heating body is sintered together with the plurality of monomers.

10. The heating sheet of claim 1, wherein the absorption base has a thickness of less than 2 mm.

11. The heating sheet of claim 1, wherein the heating body comprises a heating wire having a planar mesh structure, and the heating wire extends at least partially along a length direction of the absorption base.

12. An atomization core, comprising:
a shell, the shell comprising an airflow inlet, an airflow outlet, an accommodation space between the airflow inlet and the airflow outlet, and an atomization substance inlet communicating with the accommodation space;
an atomization base disposed in the accommodation space, the atomization base comprising an atomization channel and an opening, the atomization channel communicating with the airflow inlet and the airflow outlet, and the opening communicating with the atomization substance inlet and the atomization channel; and
the heating sheet of claim 1 disposed in the atomization base, the heating body being oriented toward the atomization channel, and a surface of the absorption base opposite the heating body being oriented toward the atomization substance inlet.

13. The atomization core of claim 12, wherein the surface of the absorption base opposite the heating body covers the atomization substance inlet.

14. The atomization core of claim 12, wherein the atomization core further comprises an absorbing material embedded in the opening; and the absorbing material is positioned between the atomization substance inlet and the heating sheet.

15. The atomization core of claim 12, wherein the shell comprises a slot; the slot extends from one end of the atomization substance inlet facing the airflow inlet towards the airflow inlet, and has a width in a direction perpendicular to an extension direction of the slot; and the width is between 0.05 and 0.35 mm.

16. An atomization device or electronic cigarette, comprising the atomization core of claim 12 and a housing; wherein the atomization core is disposed in the housing, and a storage chamber is formed between the atomization core and the housing for storing the atomization substance.
